(19) United States
(12) Patent Application Publication
(10) Pub. No.: US 2011/0000976 A1
(43) Pub. Date: Jan. 6, 2011

(54) Drip And Bubbler Irrigation Fertilizing System

(76) Inventor: Paul Anthony Roide, Palm Springs, CA (US)

Correspondence Address: PAUL ANTHONY ROIDE, PO Box 4575, Palm Springs, CA, 92263-4575, US

(21) Appl. No.: 12/497,690

(22) Filed: Jul. 5, 2009

(51) Int. Cl. B05B 17/04

(52) U.S. Cl. 239/11

(57) ABSTRACT

An irrigation fertilizing system employing a water porous mesh pouch containing a slow dissolving fertilizing medium and attaching directly to a drip type emitter device via a tube fitting or indirectly below a standard irrigation bubbler emitter or drip adjustable flow emitter by means of a flexible fitted pouch design, which allows it to be held in place under the emitter output.

### BACKGROUND OF INVENTION

1. Field of Invention

The present invention relates to the field of irrigation devices designed to conserve water, such as low volume drip irrigation emitters, bubblers, micro bubblers and any watering emitter whose output is limited in volume and is concentrated in a small given circumference around itself. More specific, in one embodiment, the present invention relates to a method and system for attaching a fertilizing device to a standard drip irrigation emitter, providing a site and fertilizer specific design that is low cost, replaceable, and which provides fertilizer each time the emitter releases water in the watering cycle of the drip irrigation system. In a second embodiment of this design, the present invention relates to a method and system for attaching a fertilizing device underneath a standard bubbler irrigation device or underneath any number of micro bubblers and micro sprinkler devices, which in the same manner provide fertilizer each time the emitting device releases water in the watering cycle of the drip irrigation system.

2. Description of Related Art

Fertilizer deliver systems are generally found within two categories, waterborne systems or dry application systems. Waterborne systems are used to feed water based fertilizers in-line to an existing irrigation system. They are physically complicated, must be plumbed into the system and remain a permanent part of the system, and must be maintained as a function of the watering rate. Waterborne systems offer the advantages of instant and concentrated fertilizing, but are expensive and difficult to use in a manner that allows for gradual, long term continuous feeding within the irrigation system. Water fertilizing systems have holding tanks of premixed fertilizer which can only be so large, so they use concentrated amounts that are dispersed fully within one or more watering cycles. They must be re-filled for the next fertilizing cycle, usually within days or weeks. Complex timing controls are needed on the injecting fertilizing unit to time the controlled release of fertilizers, further adding to the cost and complexity of the system. Therefore, most water borne fertilizer distribution is a very expensive and complicated process and is used mainly on large sprinkler type applications such as parks and golf courses or in large commercial environments.

Dry application fertilizing systems are used outside the water delivery system. Most of them contain chemicals that are manufactured to slowly release their nutrients over time but must be physically spread over the surface of the desired fertilized area such as around a plant or landscape surface and must be wetted during the watering process to achieve a nutrient release. This fertilizer is made into small pellets and is often spread by a seed spreader machine that rotates the fertilizing pellets in a drum while throwing them out in a circular pattern so that it can be easily applied to a large area by walking in circles around the area to be fertilized. This is commonly done on home lawns and small area landscaping. Larger, farm type systems use automated machinery that dispense the fertilizing pellets directly into the soil as the equipment turns the soil in the field or plants the seeds during initial stages of the farming cycle.

Dry fertilizing applicators suffer the physical problems of positioning the pellets or powder widely and evenly around the target plants, while avoiding the effects of wind, rain, and runoff and of physical displacement from workers, animals or machinery to stay in the target area and deliver its nutrients. They must also have access to a water source that will cover them fully and dissolve them at a slow, steady rate so they can be absorbed into the soil and used by a plant over consistent, long periods of time. Most of the dry fertilizers are used with sprinkler type irrigation systems over large areas where high pressure and a high volume of water are needed to dissolve the fertilizing material. Typical pellet type fertilizers can last from six months to more than a year depending on the watering cycles they receive. Over time and exposure to water and air they lose some of their fertilizing potency, especially if they are unable to dry out between watering cycles. Over wetting of the pellet type fertilizer causes it to dissolve and be applied too rapidly to the soil causing irregular and short term nutrient delivery. This is another problem in many dry fertilizer irrigation delivery systems, one that need to be watched carefully. One can sometimes see burn marks on lawns when the fertilizing pellets (or powders) are absorbed too rapidly over a short time. None of the dry fertilizing systems now in use were designed for low volume, high efficiency drip irrigation systems which typically require liquid fertilizing systems if they fertilized at all. Liquid fertilizing systems present a problem to most drip irrigation systems because the dissolved solids of the fertilizers tend to clog the emitter ports. A typical drip emitter is designed with millimeter tolerances to limit flow from high pressure sources and should not be subjected to any liquids having chemicals. Even normal tap water having high mineral (hard water) content tends to clog emitters making their replacement more regular and adding expense to the irrigation maintenance program.

Accordingly, there exists a need to provide a dry fertilizing distribution system which is simple to use and is effective with low volume drip type emitter irrigation systems and other low volume or medium volume emitters such as bubblers and micro bubblers. This system should spread the fertilizing medium evenly and gradually in a targeted area over long periods of time, in-line with the water delivery source but not effecting it. The system should be easily installed and replaced, be of low cost, and be able to be designed to match the specific fertilizing needs of a given plant or landscape by simply varying the fertilizing formula contained within it.

In the research for wet fertilizer applicators, Strong, U.S. Pat. No. 5,005,601 discloses a waterborne delivery system employing one air tank and one tank of fertilizing solution to be injected into an irrigation system. Irrigation water is allowed to fill the air tank where the remaining compressed air is allowed to pass through the top of the fertilizing container forcing the fertilizing solution from the bottom of the container into the irrigation system. Davis, U.S. Pat. No. 6,173,732 discloses a system whereby liquid fertilizer is mixed with irrigation water in a mixing chamber attached to the valve of an existing sprinkler system. Adler, U.S. Pat. No. 4,859,157 discloses a device that injects liquid fertilizer into an irrigation pipeline by means of an axial turbine impeller. Similarly, Johnson, U.S. Pat. No. 6,997,350 relates a system for adding liquid fertilizer into a sprinkler system by means of a mechanical injector comprising a paddle wheel within the water line. Astle, U.S. Pat. No. 5,383,601 describes a liquid fertilizer for a drip irrigation system wherein a reservoir holding the liquid fertilizer is held and controlled by means of inlet and outlet valves. Other liquid fertilizing applicator systems include Terrell, U.S. Pat. No. 4,768,712, Agius, U.S. Pat. No. 4,456,176 Roberts, U.S. Pat. No. 7,093,606, Jester U.S. Pat. No. 5,836,518 and Francis, U.S. Pat. No. 6,267,303. Each of these systems relies on liquid fertilizers that are in some way injected into an irrigation supply line. Water based injector type fertilizer systems are most effectively used with higher volume irrigation systems like sprinklers where large areas of plants or landscape are watered and fertilized at one time. These systems are not suited well to low volume, high efficiency systems like drip irrigation because they tend to clog the drip elements and are not effectively absorbed into the soil in small areas due to the concentration of fertilizer content. In reviewing the prior art of dry fertilizer applicators used with drip irrigation systems, only one reference was found. Greubel, U.S. Pat. No. 5,769,318 discloses a plastic housing encompassing a drip emitter and a chamber where a chemical fertilizer tablet, surrounded by a plastic jacket with holes is positioned downstream of the emitter. When water flows from the emitter within the housing, it flows through holes within the jacket and through the tablet, absorbing fertilizing chemicals and flowing outward through holes in the end of the housing. This system is ineffective in use because using a tablet in this manner will impede the natural flow of the drip emitter until it is somewhat dissolved, as the tablet itself contains no holes, only the surrounding jacket. Unless the tablet is very porous in nature water will not easily flow through it until it has dissolved to some degree and it would seem to present a problem as it softened and clogged the housing. The tablet inside such a housing would not receive enough air between watering to allow the fertilizing chemicals to dry out and therefore the tablet would become soft and disperse fertilizer too rapidly if soft or not rapid enough (or at all) if clogged within the enclosure. In addition, having the fertilizing tablet before the emitter and in the same hosing as the emitter would allow for backflow of chemicals into the emitter clogging the delicate and microscopic emitter plunger with dissolved solids and keeping it either permanently closed shut or wide open, as does even high PH (hard or calcified) supply water over time. It would also seem to be complex to manufacture and difficult to keep dirt and foreign materials from entering the drain holes, another potential source of water stoppage. Finally, it is difficult to use in the field since there is no way to tell when the tablet has dissolved and the device needs to be replaced. The present invention described below overcomes these design flaws and delivers a device that works independent of and with any external drip emitter as well as with other low volume emitters like bubblers and variable flow emitters now common to the irrigation industry. It creates no chemical backflow that can cause emitter damage while fully draining after each watering for long chemical life and low waste. In addition, its fertilizing source can be visually checked for content during maintenance and easily changed when needed.

### SUMMARY OF INVENTION

The invention involves three distinct embodiments. The first allows connection directly to a drip button emitter's output via plastic tubing and is composed of a mesh material sewn in the shape of a small pouch with a seam at the sides and end and attached to a plastic nipple at the opposite end. The pouch holds fertilizer pellets within and as water enters the pouch through the nipple end it disperses over and through the fertilizer pellets, thereby absorbing the fertilizer medium through a slow release process and then exits the pouch through the mesh material which surrounds it. The exiting water, enhanced by the fertilizer medium, is then absorbed into the ground around the plant. Soon after the drip cycle ends, the fertilizer medium, being open to air by means of the mesh that surrounds it, is able to aerate and dry, preserving itself for the next watering cycle. The fertilizer medium is made to last for a 6-36 month period, depending on the size of the pouch and quantity of fertilizing medium involved and can be replaced easily and effectively, allowing for use of different fertilizers for specific plants and growing seasons. This embodiment also contains a means to prevent chemical backflow from entering the water supply system by means of a plastic nipple that is angled downward from level toward the fertilizing pouch. Even if the pouch and emitter placed flat on the ground, the nipple will prevent any water chemically enhanced within the pouch from flowing upward back into the drip emitter. Another means of preventing backflow with upright (staked) drip emitters is by use of a tube clip that keeps the pouch below the top of the emitter keeping fertilized water from entering the emitter or water source.

The second embodiment of this design is similar in that it too is comprised of a mesh material which holds a fertilizing medium, preferably pellets or small particles which present the greatest surface area to incoming water. The difference in this embodiment is that the pouch is designed in a circular shape to fit over, around and under a standard sized medium volume bubbler emitter. It therefore does not connect via plastic drip line tubing but rather physically attaches below the bubbler or adjustable flow emitter head by means of the stretchable elastic nature of the pouch material, which is designed to be adjustable in diameter to fit to accommodate multiple bubbler sizes. As water bubbles from this type of emitter and flows downward, it passes through the mesh pouch and similar to embodiment one, absorbs the fertilizer medium upon contact and flows further downward to the ground as fertilizer enhanced water, providing the same support to the plant or growing organism within its watering (target) range. Similar as in embodiment one, the fertilizing device can be made to last a specific period of time and contain specific chemicals for specific growing cycles by varying the size of the pouch and chemical content of the fertilizer respectively.

The third embodiment of this design is again one that is circular like that of embodiment two but smaller in size and made to fit underneath standard upright or vertical drip emitter anchors used with adjustable flow emitters, micro bubblers and micro sprinklers. The closed pouch design forms a circle and can be slipped underneath the upright drip tube as they are inserted into the ground and will become wetted by the drip emitter run off and allow the chemicals within the pouch to be absorbed by the run off and applied directly to the plant within the drip emitter range. Each embodiment is designed to fit with a specific type of application but each design employs the same porous and flexible pouch material containing chemical inserts and relies upon the same methods to apply fertilizer in each drip application. The pouch is designed of flexible material and will stretch to fit over a standard size bubbler head or stretch to fit around a upright drip anchor as is it inserted in the field. The present invention thus provides a very cost effective way for growers and landscapers to fertilize with very low associated maintenance and in conjunction with their existing drip irrigation system. It allows for easy installation, maintenance and replacement and can be made into a variety of fertilizing specifications desired by the grower at any time. For example, the grower may specify a certain fertilizing formula during early plant growth and want to vary that formula as the plant matures and needs others nutrients for pollination or flower/fruit growth. The grower can meet this change simply by replacing the pouches on the targeted plants of concern with another desired fertilizing mix, while leaving the previous blend in place for less mature plants. The present invention allows then for multiple fertilizing blends to be applied within the same system at different points by targeting each individual fertilizing pouch. The pouches are easy to change and do not degrade over time. In addition, the present invention enhances the drip irrigation system by fully draining the emitters on the completion of each watering cycle and by closing off the emitters to outside air and the harmful effects of oxidizing water, which tends to clog the small emitter tolerances and parts within a standard drip emitter.

### BRIEF DESCRIPTION OF THE DRAWINGS

FIG. 1 is a side view of embodiment one of the present invention attached to drip line and designed to attach to a standard drip emitter along with a side view of embodiment two of the invention as a round fertilizing pouch designed to be placed over a standard bubbler emitter head. It also shows a side view of embodiment two and embodiment three.

FIG. 2 is a side view of embodiment one of the invention attached to an drip line and standard button type drip emitter.

FIG. 3 is a front view of the embodiment one design attached an upright emitter anchor showing use of the backflow prevention clip.

FIG. 4 is a side view of embodiment one of the invention showing an exploded view of the pouch nipple and its internal anti-gravity flow design and how the pouch attaches to it.

FIG. 5 is a front and side view of embodiment two of the invention as it attaches and is used with a standard bubbler type emitter supported by a riser irrigation pipe.

FIG. 6 is a front and side view of embodiment three of the invention as it attached and is used with variable output drip bubbler and fan spray emitters attached to vertical upright staked anchors.

### DESCRIPTION OF THE ILLUSTRATED EMBODIMENTS

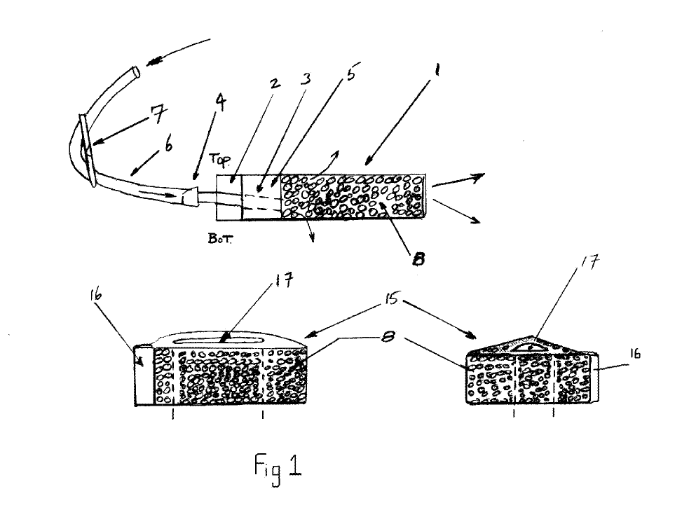

Each of the three preferred embodiments of the drip irrigation fertilizing system are shown in FIGS. 1 thru 6 and are comprised of the following components:
1. Fertilizer Pouch
2. Nipple
3. Nipple Canal
4. Nipple Barb Tip
5. Nipple Base
6. Drip tubing
7. S Ring Clip
8. Fertilizer Pellets
9. Drip Emitter
10. Emitter Input Port
11. Emitter Output Port
12. Tubular Emitter Support Rod
13. Threaded Support Base
14. Irrigation Line with Threaded Opening
15. Circular Fertilizer Pouch
16. Flexible Pouch Seal
17. Variable Pouch Diameter
18. Bubbler Head
19. Irrigation Pipe Riser
20. Variable Rate Stake Emitter
21. Emitter Support Stake
22. Staked Emitter input Port

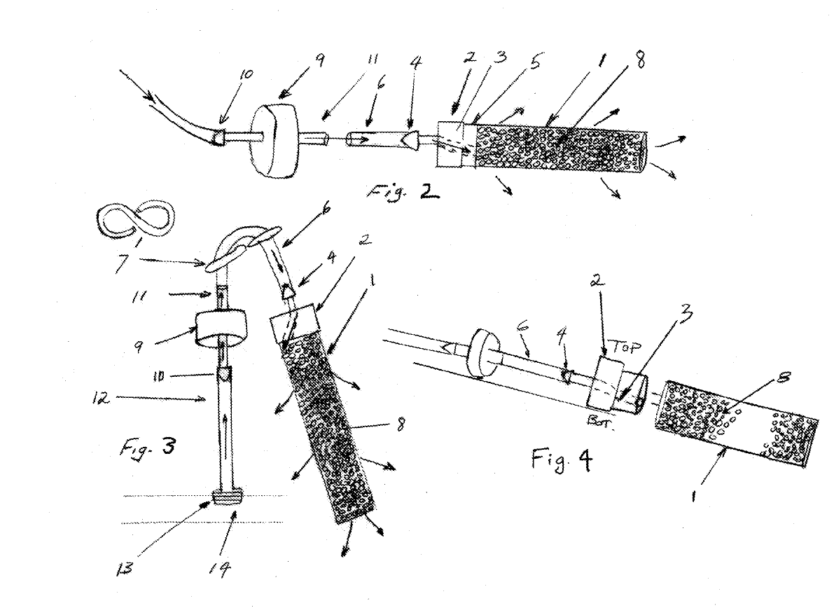

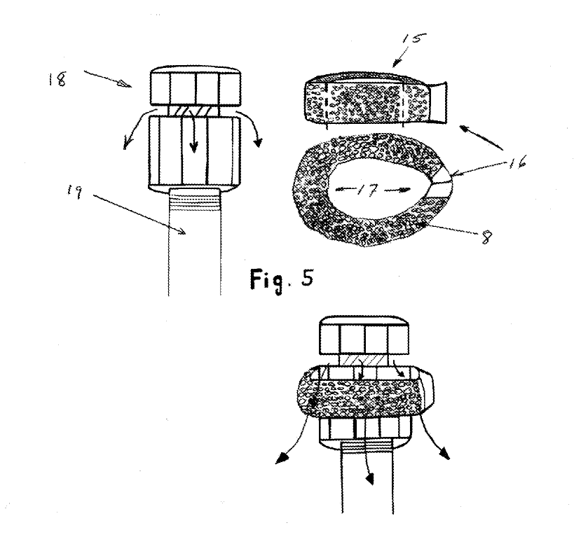

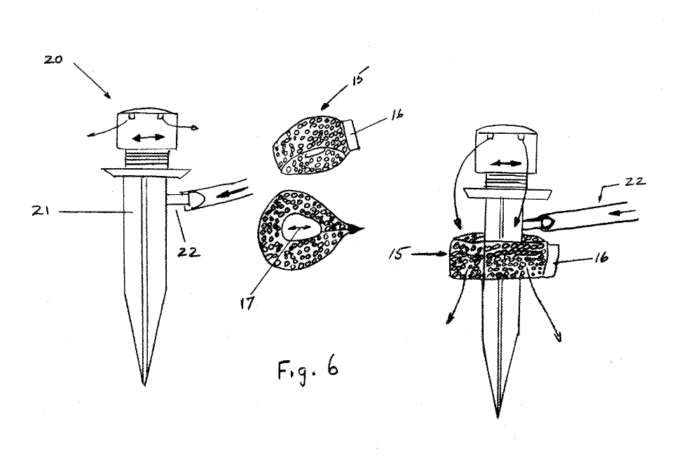

In preferred embodiment one of the present invention shown in FIG. 2, the center of the design is fertilizer pouch 1 which encloses and seals fertilizing medium comprised of small chemical pellets 8 and is attached to a plastic nipple 2 having an internal passage or nipple canal 3 that is sloped downward from the top of the nipple to its bottom as shown in a more detailed view in FIG. 4. This creates the necessary antigravity-back low prevention as this embodiment is normally used on ground level near the targeted plant and does not rely on an emitter that is raised above ground level as shown in FIGS. 2, 4 and 5. The device orientation and markings must therefore be observed to preserve this effect. The nipple 2 attaches on one side to the fertilizing pouch 1, sealed to the nipple, and at the other side it attaches to a standard drip line 6 via its barbed nipple input 4. This drip line then attaches to the drip emitter 9 at its output 11 via this same drip line 6 which closes the irrigation system from its supply source where it connects to the drip emitter input at 10. Water flows from the irrigation source at 10 into the drip emitter, which limits the volume of water applied and then flows outward into the nipple, through the sloped nipple canal and into the fertilizer pouch. At this point the water flows over the fertilizing pellets 8 inside the pouch 1, absorbing nutrients from them as it does and exits the pouch through its small mesh openings flowing onto the ground surrounding the targeted plant. Once the irrigation source is turned off, water continues to drain via gravity flow from the drip emitter into the sloped nipple and outward into the fertilizing pouch, where it can fully evacuate water supply line 11, clearing any potential particulate buildup inside the drip emitter and allowing the fertilizing pellets within the pouch to air dry to preserve their hardness and fertilizing integrity for future watering cycles. The fertilizing pouch is sealed from the elements of wind and other outside influences and can be easily inspected for content since its mesh webbing is transparent in color and its content is easily viewed. Even in the event of a rain downpour where the pouch is exposed to flooding over time it will aerate quickly once the water subsides and will not be permanently damaged or effected. In preferred embodiment two, FIG. 3 shows this same fertilizing pouch used with a drip bubbler emitter that is commonly mounted on hollow tubular riser 12 as it attaches to the irrigation supply line 14 via a threaded connection 13, and which is supported upright mechanically by this method. Water flows from the irrigation supply line 14 through the hollow tubular support rod and into the drip emitter. In this embodiment as the water flows out of the emitter through the drip line 6, the drip line is gently bended downward by use of “S” Ring 7, which keeps the drip line pointed downward into the fertilizing pouch without crimping it or affecting the flow. This serves as an additional means to prevent back flow of water into the emitter as does the sloped nipple when used in ground based emitter applications. The water continues to flow into the fertilizing pouch 1 through nipple 2 whereby the pellets are again rinsed by this flow and the fertilizing medium is absorbed in the process, flowing onto the ground and into the target area. Back flow is a serious design concern since the drip emitter can become easily clogged and rendered useless if the fertilizing chemicals were allowed to flow backwards into the emitter. The emitter contains a rubber plunger that is designed to open and close with applied pressure but can easily seal itself open or closed if microscopic particles in the water are allowed to dry near them. Having a closed loop system by the addition of the present design to the drip irrigation system will not only prevent back flow, but keep the emitter cleaner and drier since water drains fully each time and air is prevented from re-entering the emitter. Air, water and sunlight tend to create deposits on the output side of drip emitter and having this closed system prevents the harmful effects of oxidation from damaging the emitter, an added benefit of the present invention that extends the life and lowers the overall maintenance cost of the irrigation system. In preferred embodiment 3 of the present invention, shown in FIGS. 5 and 6, the fertilizer pouch 15 takes on a circular shape to be used with bubblers 18 and staked emitters 20. The fertilizing pouch 15 is made of the same mesh material as that in embodiment one 1 and contains the same fertilizing pellets 8 inside. In this particular design both ends of the pouch are sealed at 16 forming a flexible joint that is able to stretch over a standard size bubbler head 18 by means of a slightly varying diameter 17. The fertilizing pouch of FIG. 5 is now circular and able to flex to slide over the top of a standard size bubbler emitter head 18 and hold itself in place through the stretching spring action of the mesh material just under the bubbler emitter output, which allows water from the bubbler to enter the pouch and dissolve the fertilizer pellets in the same gradual manner as before, delivering water and fertilizing nutrients to the target area under the bubbler. The bubbler 18 is usually threaded into an irrigation pipe 19 which extends above the ground to allow for watering above the surface of the target area. In the same manner as before, when the water cycle is finished the water will drain completely from the pouch and it will aerate itself between watering cycles, insuring that the fertilizing pellets remain dry, hard and potent for many watering applications. In this embodiment there is no need for back flow prevention since the pouch is below the emitter output and is physically disconnected from it preventing water from ever moving upward into the emitter output. As the pouch 15 gets smaller over time due to the shrinkage of the fertilizer pellets being washed away by hundreds (or thousands) of watering cycles, it will compress itself due to tension in the flexible seam 16 to maintain in position below the bubbler head emitter outputs and not slip down off of it. Therefore, no maintenance is required once the fertilizing delivery system is set in place other than pouch life cycle replacement. Depending on the watering cycle rates, the pouches are designed to last years and deliver nutrients each time the water is applied at a very low cost and over a very long period.

Finally, in another application of preferred embodiment three shown in FIG. 6, the present invention is applied to staked micro emitters whose outputs are adjustable and which include a wide variety of designs including variable output fan sprayers, drippers, bubblers and any other drip emitter whose output is concentrated in a small diameter at reduced flow rates. These emitters are usually formed as a one piece design of injection molded plastic where the support stake and emitter base 21 and the emitter input port 22 are molded as one piece. The top or cap of the emitter 20 then screws on and serves to vary the flow rate from the emitter. In this application, the same circular fertilizing pouch is used as with the bubbler shown in FIG. 4 but the diameter of the pouch 17 is made smaller and more triangular to fit the standard shape and width of the stakes used with these type of devices. The pouch is constructed in the same manner, contains the same fertilizing medium and operates in the same way. The flexible joint 16 performs the same function as in earlier embodiments and keeps the pouch snug to the emitter stake underneath the emitter output. In this application the pouch is first slipped through the stake before it is planted in the ground and is wedged between the ground and the emitter head. As waters flows from the emitter it enters the pouch and dissolves the fertilizing pellets into the target area.

What is claimed is:

1. A method of a providing a cost effective drip irrigation fertilizing system which can be designed for specific emitters and used in-line with those emitters, attached and removed easily without disrupting or modifying the water deliver system and whose chemical content can be varied for specific plants, growing cycles and lifecycles, wherein the improvement comprises;
i. A pouch made of flexible mesh material designed to hold the fertilizing medium and sealed from outside elements entering it,
ii. A timed release fertilizing medium inserted into the mesh pouch and shaped into small geometric shapes, preferably round, to maximize the surface area exposed to the incoming water that flows over it while remaining large enough to stay within the confines of the mesh interior, this medium could be either chemical in composition or organic.
iii. A nipple designed to connect to standard drip line tubing and integrally connected to the pouch when used with standard drip button emitters, and designed to allow water to flow downward from input to output to prevent backflow,
iv. A means of design to size and secure the fertilizer pouch around a specific diameter pipe or emitter head such as a bubbler emitter head, that is adjustable in nature by use of a flexible mesh material so that it fits a multitude of variable flow emitter head sizes,
iv. A means of design to size and secure a fertilizer pouch underneath the
v. most common stack or upright type anchored drip emitters, including variable output drip emitters, micro bubblers, micro sprinklers and other small area drip emitters by use of a flexible joint.
vi. A means of design to allow visual indication of the fertilizing medium to detect when it needs to be replaced.
vii. A means of design to vary the size and chemical content of each specific pouch to modify the fertilizing system for specific plants, soils, environments and growing and watering cycles,
viii. A means of design that does not limit or affect the water delivered to the growing medium either when first installed or left un-maintained for periods beyond the life cycle of the fertilizing element,
ix. A means of design which does not allow for back flow contamination of the water deliver system by using techniques that allow for the gravity flow of water in the device.
